(19) United States
(12) Patent Application Publication
(10) Pub. No.: US 2012/0243967 A1
(43) Pub. Date: Sep. 27, 2012

(54) MOVABLE CONVEYOR FOR LOADING A CONTAINER

(76) Inventor: Samuel Waldner, Decker (CA)

(21) Appl. No.: 13/423,397

(22) Filed: Mar. 19, 2012

Related U.S. Application Data
(60) Provisional application No. 61/454,626, filed on Mar. 21, 2011.

(51) Int. Cl. B60P 1/40

(52) U.S. Cl. 414/523; 414/526

(57) ABSTRACT

A container for example for a seeder includes a filling auger mounted on the container with a bottom hopper and an upper filling spout with the auger being mounted on a lift system arranged for movement in a direction inwardly and outwardly relative to the side of the container to different positions relative to the container for cooperation with a supply. The hopper is supported on two pairs of castor wheels. A cradle is provided on the container for holding the auger in transport position, with the cradle carried on an arm which is swung out from the side by a linkage connected to the lift system as the auger is raised from the transport position. The lifting action also tilts the hopper wheels to the ground.

This applications claims the benefit under 35 USC 119(e) of Provisional application 61/454,626 filed Mar. 21, 2011.

This invention relates to an apparatus including a movable conveyor movable to allow the hopper of the conveyor to be moved to positions to cooperate with a supply vehicle.

### BACKGROUND OF THE INVENTION

The loading of the tank of a seeder has become more difficult in recent years due to the increase in size of the container or tank, due to the difficulty of reaching the loading opening of the tank and due to the current use of belly-dump trailers rather than the conventional lift trailer.

Various arrangements have been used to resolve this problem and many seeder tanks now carry a loading mechanism in the form of a conveyor which is mounted on a suitable mounting assembly at the side of the tank. Generally the conveyor duct is mounted at the end of an arm which can swivel side to side without a vertical axis and the duct itself can also swivel about a pin at the end of the arm so that the location of the hopper at the lower end of the duct can be manoeuvred to different positions. However these arrangements are generally limited to arcuate movement by virtue of vertical pivot axes so that the hopper is limited in its movement. While this is acceptable for a trailer of the type which dumps at the rear, so that the trailer can be backed up to the hopper, it is not acceptable or raises significant difficulties in the event that it is required to unload the trailer from the center or from a belly-mount discharge opening since the trailer and its tractor are difficult to manoeuvre, since the seeder itself can not be manoeuvred in the field and since the loading conveyor has limited movement.

Other arrangements have been proposed to overcome this problem but they are very expensive including providing conveyors mounted on the trailer itself. These have generally not been satisfactory.

In U.S. Pat. No. 7,488,149 issued Feb. 10, 2009 corresponding to Canadian Patent 2,510,966 by the present Applicant discloses a container for example for an air seeder which includes a filling conveyor mounted on the container with a bottom hopper and an upper filling spout with the conveyor being movable in a direction inwardly and outwardly relative to the side of the container to different positions relative to the container for cooperation with a supply. This is achieved by mounting the conveyor on a swivel coupling at the outer end of an arm which can be raised and lowered by pivotal movement about an inner end at the container. The hopper is supported on two pairs of ground wheels, each pair being arranged on a respective side of the hopper for supporting the respective side and each pair comprising a respective one of a pair of castor wheels mounted at respective ends of a pivotal beam extending along the respective side of the hopper and pivotal about an axis transverse to the hopper.

### SUMMARY OF THE INVENTION

It is one object of the invention to provide an improved filling system for a container such as a seeder tank in which the conveyor is movable to allow the hopper of the conveyor to be moved to positions to cooperate with a supply vehicle.

According to one aspect of the invention there is provided an apparatus comprising:

a container having a side wall;

a conveyor duct having a conveyor member mounted therein and operable to move a particulate material within the duct from a lower feed end to an upper discharge end;

a hopper at the lower feed end into which the particulate material can be poured;

a discharge spout at the upper discharge end for discharging the particulate material from the duct;

at least one ground wheel on the hopper for supporting the hopper for movement over the ground;

a mounting assembly for mounting the conveyor duct on the container for movement relative thereto between a transport position along the side wall of the container to a deployed position extending outwardly from the side wall with the ground wheel of the hopper on the ground, the mounting assembly comprising:
a support bracket mounted on the side wall of the container;
a first portion mounted on the support bracket for pivotal movement about an upright axis such that the first portion can turn about the axis from a position along the side wall of the container to a position extending outwardly from the side wall of the container;
an arm portion having an inner end mounted on the first portion for pivotal movement about a transverse axis on the first portion such that the arm portion can move from a raised position to a lowered position;
and a coupling attaching an outer end of the arm to the conveyor duct;

and a cradle carried by the container for receiving the conveyor duct therein when in a transport position along the side wall of the container;

the cradle being carried on an arm movable relative to the container so as to be moveable relative to the container.

The cradle can be mounted by the arm on the side wall (directly or indirectly) or more conveniently on the same bracket as the mounting assembly. If the elements are on a common bracket, the whole structure can be supplied as a common assembly for attachment to the seeder The term “arm” is not intended to limit the structure concerned to any particular shape of the component which fulfills this function of carrying and moving the cradle.

Preferably the arm is arranged to move the cradle from a retracted transport position adjacent the side wall to an extended position away from the side wall for releasing the conveyor duct.

Preferably the arm moves horizontally.

Preferably there is provided a linkage from the mounting assembly for moving the arm in response to operation of the mounting assembly.

Preferably the linkage is arranged to move the arm horizontally to carry the cradle away from the side wall when the mounting assembly is operated to lift the conveyor duct.

Preferably the cradle is arranged such that lifting of the conveyor duct by the mounting assembly causes the conveyor duct to tilt about the cradle to lower the ground wheel to the ground.

Preferably the cradle is arranged such that lifting of the conveyor duct by the mounting assembly causes the conveyor duct to tilt about the cradle to lower the ground wheel to the ground.

comprising:

Preferably the conveyor duct comprises an auger which includes a first portion extending from the hopper and a second portion extending from an end of the first portion to the spout, wherein the first position is of smaller diameter than the second portion.

Preferably the first portion is at an angle to the second portion and generally parallel to the hopper floor.

According to a second aspect of the invention there is provided an apparatus comprising:

a container having a side wall;

a conveyor duct having a conveyor member mounted therein and operable to move a particulate material within the duct from a lower feed end to an upper discharge end;

a hopper at the lower feed end into which the particulate material can be poured;

a discharge spout at the upper discharge end for discharging the particulate material from the duct;

at least one ground wheel on the hopper for supporting the hopper for movement over the ground;

a mounting assembly for mounting the conveyor duct on the container for movement relative thereto between a transport position along the side wall of the container to a deployed position extending outwardly from the side wall with the ground wheel of the hopper on the ground, the mounting assembly comprising:
a support bracket mounted on the side wall of the container;
a first portion mounted on the support bracket for pivotal movement about an upright axis such that the first portion can turn about the axis from a position along the side wall of the container to a position extending outwardly from the side wall of the container;
an arm portion having an inner end mounted on the first portion for pivotal movement about a transverse axis on the first portion such that the arm portion can move from a raised position to a lowered position;
and a coupling attaching an outer end of the arm to the conveyor duct;

and a cradle carried by the container for receiving the conveyor duct therein when in a transport position along the side wall of the container;

the cradle providing a fulcrum at a position part way along the conveyor duct and arranged such that movement of the arm portion downwardly from the raised position causes a lifting movement of the hopper from the ground.

According to a third aspect of the invention there is provided an apparatus comprising:

a container having a side wall;

a conveyor duct having a conveyor member mounted therein and operable to move a particulate material within the duct from a lower feed end to an upper discharge end;

a hopper at the lower feed end into which the particulate material can be poured;

a discharge spout at the upper discharge end for discharging the particulate material from the duct;

at least one ground wheel on the hopper for supporting the hopper for movement over the ground;

a mounting assembly for mounting the conveyor duct on the container for movement relative thereto between a transport position along the side wall of the container to a deployed position extending outwardly from the side wall with the ground wheel of the hopper on the ground, the mounting assembly comprising:
a support bracket mounted on the side wall of the container;
a first portion mounted on the support bracket for pivotal movement about an upright axis such that the first portion can turn about the axis from a position along the side wall of the container to a position extending outwardly from the side wall of the container;
an arm portion having an inner end mounted on the first portion for pivotal movement about a transverse axis on the first portion such that the arm portion can move from a raised position to a lowered position;
and a coupling attaching an outer end of the arm to the conveyor duct;

wherein the conveyor duct comprises an auger which includes a first portion extending from the hopper and a second portion extending from an end of the first portion to the spout, wherein the first position is of smaller diameter than the second portion.

Preferably the first portion is at an angle to the second portion and generally parallel to the hopper floor.

The arrangement described above can be used in conjunction with the construction described and claimed in the above cited patents or may be used with other similar arrangements which act to move the conveyor duct between the retracted transport position and the deployed position.

### BRIEF DESCRIPTION OF THE DRAWINGS

One embodiment of the invention will now be described in conjunction with the accompanying drawings in which:

FIG. 1 is a rear elevational view of a conveyor apparatus for mounting on the side of a seeder tank for loading the tank from a supply vehicle.

FIG. 2 is a rear elevational view of the same apparatus as in FIG. 1 however moved inwardly to a retracted position.

FIG. 3 is an isometric view of the mounting assembly itself with the conveyor duct removed.

FIG. 4 is a rear elevational view similar to FIG. 1 on an enlarged scale.

FIG. 5 is a rear elevational view similar to FIG. 2 on an enlarged scale.

FIG. 6 is a top plan view of the mounting assembly of FIG. 1.

FIG. 7 is an isometric view of the hopper of the duct.

FIG. 8 is a rear elevational view of the hopper on an enlarged scale in an extended position shown in FIG. 1.

FIG. 9 is a rear elevational view of the hopper shown in the retracted position of FIG. 2.

FIG. 10 is a rear elevational view of an alternative embodiment in an extended position.

FIG. 11 is a rear elevational view of the embodiment of FIG. 10 in the retracted position.

FIG. 12 is a top plan view showing schematically the construction described in relation to the above drawings together with an additional cradle arrangement according to the present invention.

FIG. 13 is view along the lines 13-13 showing the arrangement of FIG. 12 in the transport position.

In the drawings like characters of reference indicate corresponding parts in the different figures.

### DETAILED DESCRIPTION

The following description is taken from the above cited patents for completeness.

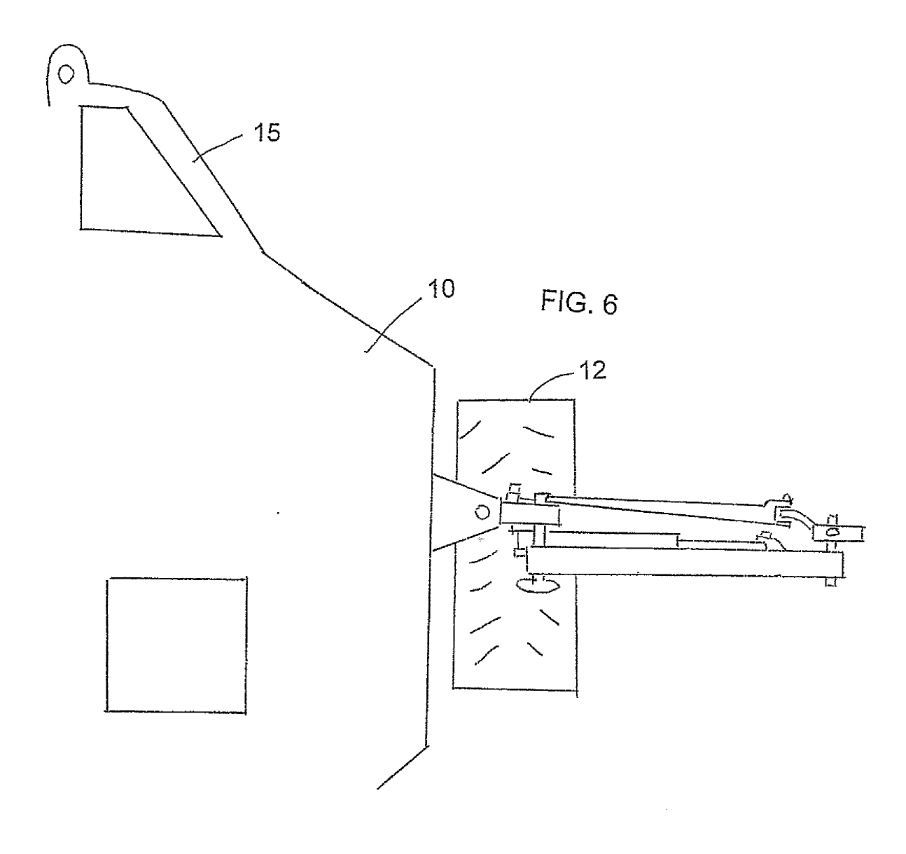

A tank 10 of a seeder includes a top opening 11 through which the tank can be filled. The tank is mounted on ground wheels 12 at respective sides of the tank carried on an axle 13. The tank is towed by a hitch 15 (FIG. 6) at a suitable location relative to the seeder. The apparatus of the present invention provides a loading device generally indicated at 16 for loading seed materials from a supply location generally indicated at 17 through a conveyor 18 into the opening 11. The conveyor 18 includes a duct 19 which has a discharge spout 20 at the upper end and a hopper 21 at the lower end.

The conveyor duct is generally tubular and contains a conveyor member driven by suitable drive mechanisms (not shown). The conveyor member is commonly in the form of an auger flight but may be replaced by a belt or in some cases both a belt and a flight are used. Other transport elements may also be used since the operation of the conveyor itself is not part of the present invention and may different arrangements are available to one skilled in the art.

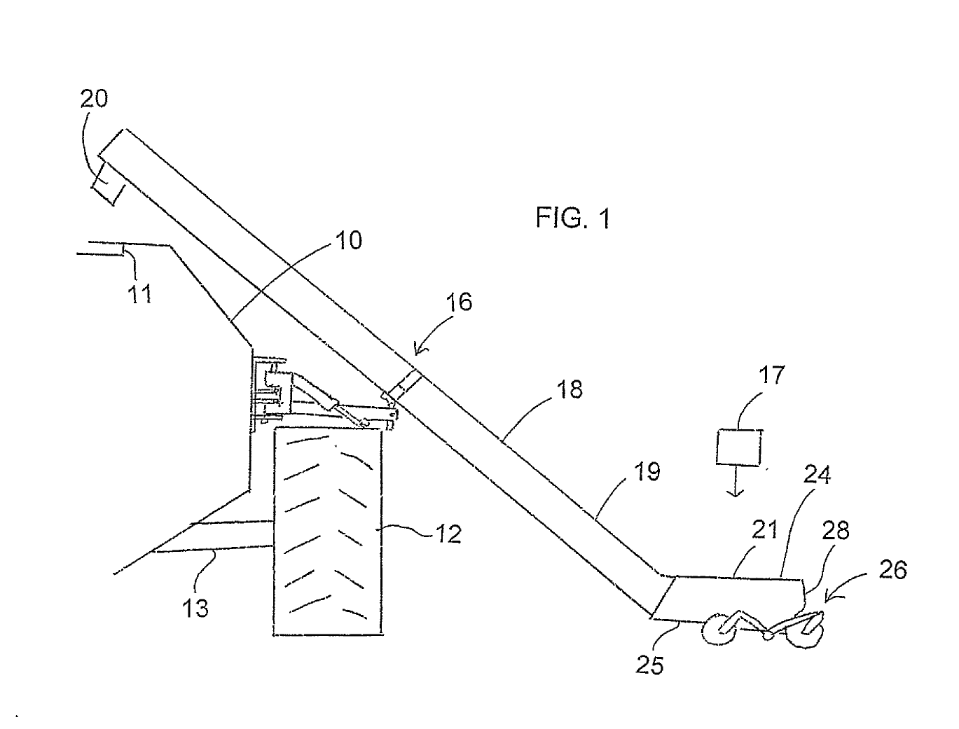

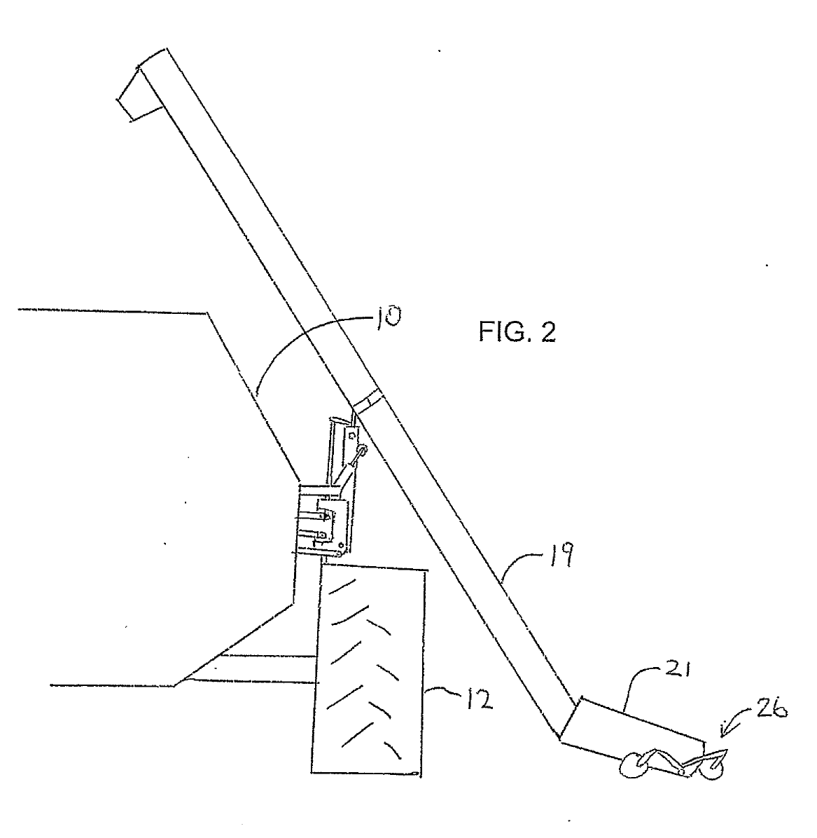

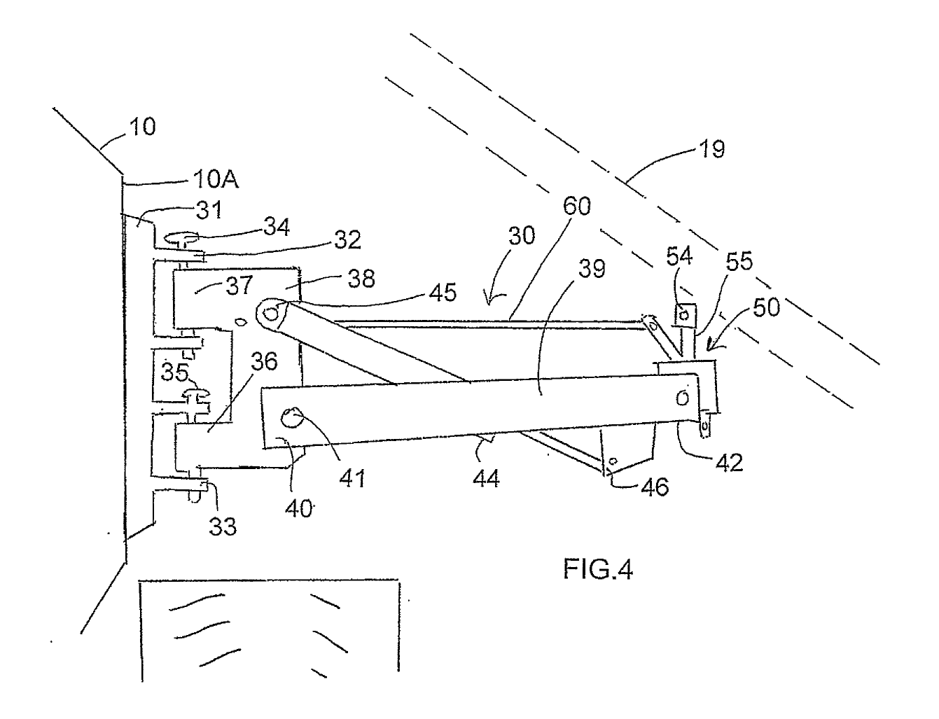

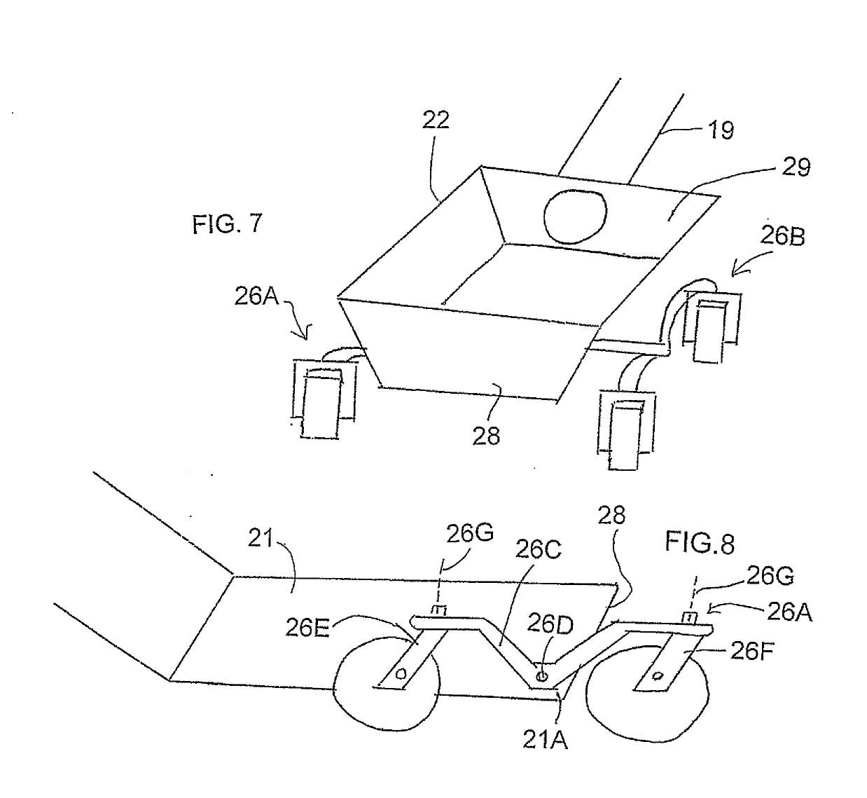

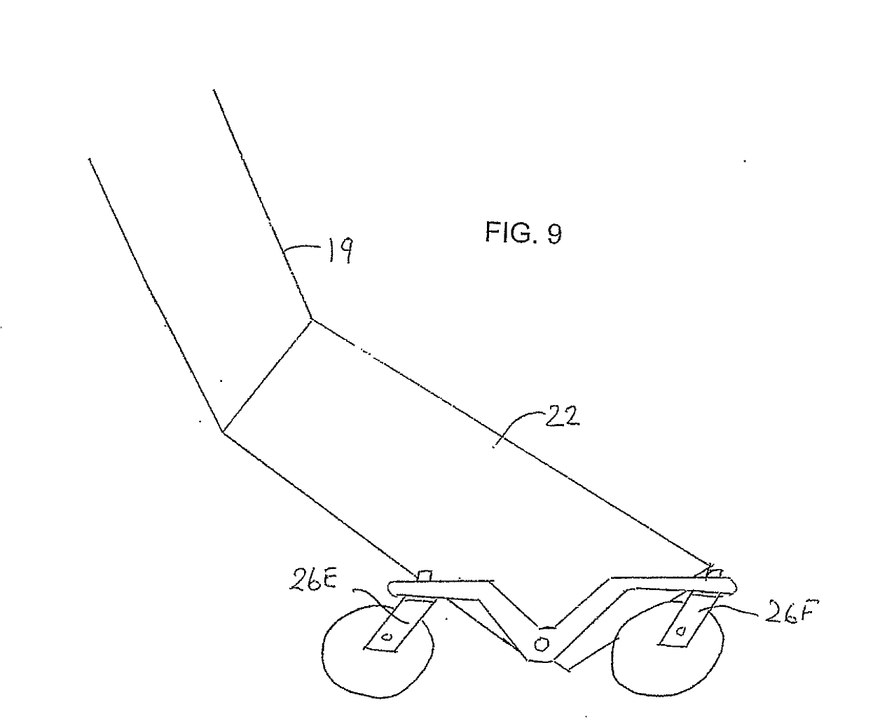

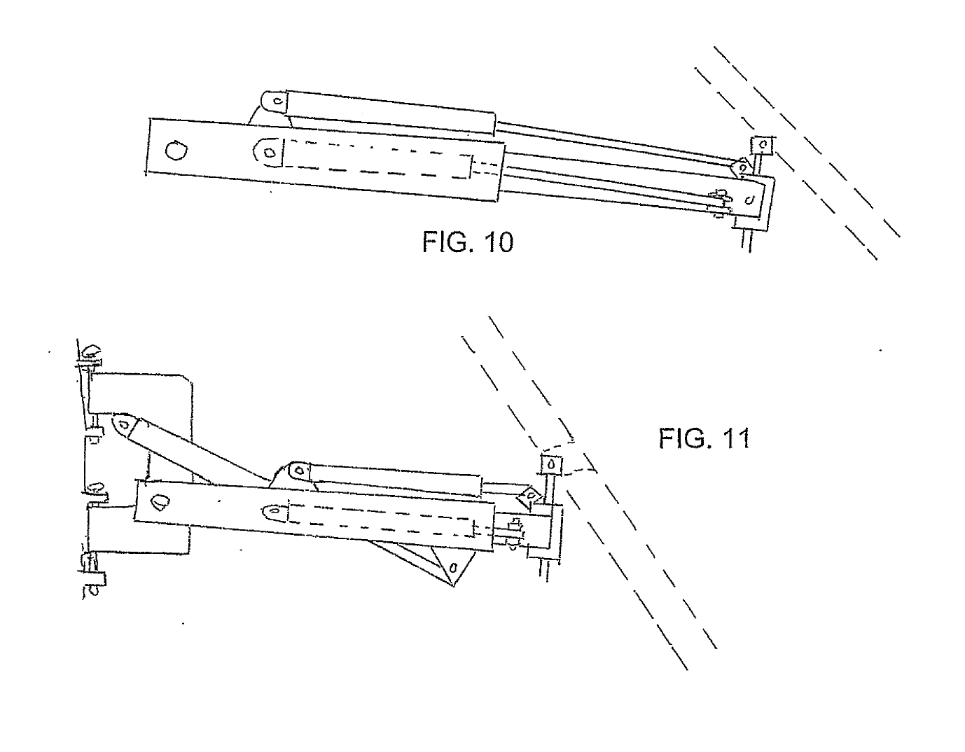

The hopper 21 forms a generally rectangular container 22 as best shown in FIG. 7 with a front wall 28 and a rear wall 29 through which the tube 19 extends. The hopper is arranged to receive the material from the supply 17 and to collect that material for engagement with the transportation element within the tube 19 for carrying the material to the discharge spout 20. The hopper has an upper surface 24 and a bottom wall 25 and these are arranged at an angle to a longitudinal axis of the tube 19. The hopper is mounted on ground wheels generally indicated at 26 for allowing movement of the hopper in required directions across the ground. As best shown in FIG. 4, the tube 19 is carried on a mounting assembly 30 for movement relative to the tank 10 to required positions of the hopper on the ground. In particular the mounting assembly 30 allows the hopper 21 to move from the extended position shown in FIG. 1 in a direction at right angles to the side wall of the tank in a direction longitudinally of the duct from the extended position to the retracted position shown in FIG. 2.

The amount of movement between the extended and retracted positions is of the order of 6 or 7 feet so that the hopper 21 can move from a position straddling the centerline of a vehicle along side the tank to a position retracted beyond the inside wheels of the vehicle. As the width of a traditional transport vehicle of this type is of the order of 4 feet, a movement distance of the order of 6 feet is necessary to move from a position in which the hopper is clear of the wheels to a position in which the hopper is straddling the centerline and has a outer edge 28 at the outer edge of the discharge opening of the vehicle.

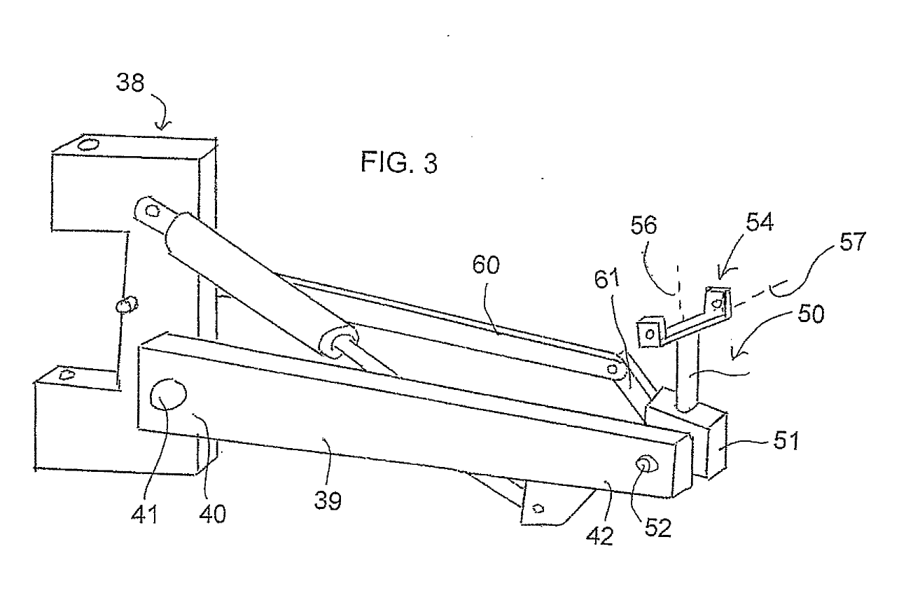

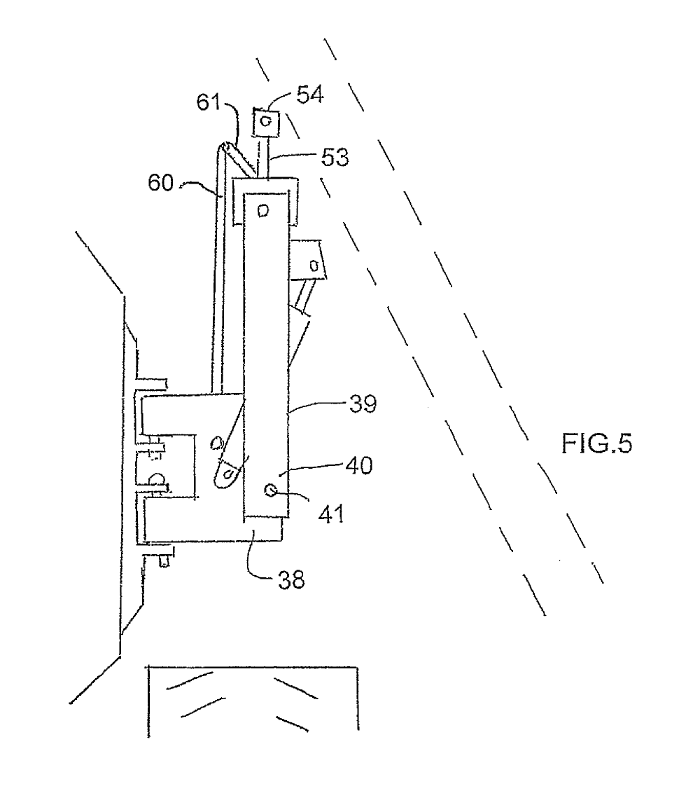

The mounting assembly 30 comprises a bracket 31 which is attached to the side 10A of the tank 10. The bracket 31 includes a pair of devises 32 and 33 each defining a vertical pivot axis by way of a vertical pin 34, 35. These devises receive end projections 36 and 37 of a first pivot member 38 which is therefore carried on the bracket 31. The first pivot member 38 thus pivots about a common vertical axis defined by the pins 34, 35 and provides a support for a pivot arm portion 39 which has an inner end 40 mounted on a horizontal pivot pin 41 so that the outer end 42 of the arm can move from a fully extended position which is generally horizontal as shown in FIGS. 3 and 4 to a vertical position shown in FIG. 5.

The movement of the arm 39 about the pivot pin 41 is obtained by a drive member 44 in a form of a hydraulic cylinder. The hydraulic cylinder is connected at one end by a lug 45 to the first portion 38 at a position above the arm 39 and extends therefrom to a clevis 46 on the underside of the arm. Thus extension of the cylinder acts to pivot the arm about the pin 41 from the extended position shown to the raised position shown in FIG. 5.

The duct or tube 19 is mounted on the outer end 42 of the arm by a swivel coupling generally indicated at 50. The swivel coupling 50 best shown in FIG. 3 includes a base block 51 mounted on a horizontal pivot pin 52 extending through the outer end 42 of the arm. Thus the block 51 is pivotal about a horizontal transverse axis. The block 51 carries a post 53 which stands upwardly from the block and carries at its upper end a clevis 54 for receiving a bracket 55 welded to the underside of the tube 19. The post 53 can rotate about an axis 56 longitudinal of the post and extending through the block 51. The clevis 54 defines a pivot axis 57 which extends across the bracket 55 of the tube so as to allow the tube to pivot relative to the post.

The post 53 is maintained substantially upright so that the axis 56 is substantially upright at all times during the movement of the arm 39. Thus in the position shown in FIG. 4 the post 53 is upright and in a position shown also in FIG. 5 the post 53 is upright. This supports the clevis 54 and the tube carried thereby at a position spaced from the outer end 42 of the arm so it is properly supported at a required position without abutment of the tube with the arm. The post 53 is held upright by a crank 60 which has an inner end attached to the first portion 38 and an outer end which engages with a lever 61 carried on the block 51. Thus as the arm pivots upwardly, the crank 60 pushed on the lever 61 thus tending to pivot the block 51 about the pin 52. The geometry is arranged so that the post 53 is maintained substantially vertical. This holds the tube upwardly above the outer end of the arm at all times and ensures sufficient lift on the tube in the position shown in FIG. 5 so that the tube is raised upwardly sufficiently to clear the top of the tank.

The tube and the bracket can thus be pivoted to a position along side the tank for storage and transportation. Suitable latching arrangements can be provided to hold the tube in place. This is achieved by rotating the first portions 38 about the vertical axis defined by the pins 34 and 35 so that the bracket moves to the along side position following which the tube can also be rotated on the post 53 to a required position.

The extension movement between the retracted position of FIG. 2 and the extended position of FIG. 1 has a length of movement of the hopper of the order of 6 to 7 feet. This is achieved without having an arm 39 of the same length and the arm can be of reduced length of the order of 3 to 4 feet since there is a compound movement of the hopper in its movement from the retracted to the extended position. In particular it will be noted that the angle of the tube is also changed since the hopper remains resting on the ground and thus, as the hopper moves inwardly the tube must rotate around the axis 57 of the clevis 54 to a more elevated angle. In FIG. 1 the angle is shown at the order of 45°. In the position of FIG. 2, the angle is closer to 60° and this change in angle is sufficient to move the outside end of the hopper by the required distance to clear the supply vehicle.

Additional movement of the hopper can be obtained by pivoting the arm and first portion 38 about the vertical axis defined by the pins and the tube can be maintained at the same angle to the side of the tank by pivoting the tube around the post 53.

The ground wheels which support the hopper provides support for the hopper on both sides of the hopper and includes two pairs of ground wheels indicated at 26A and 26B respectively. Each pair of ground wheels comprises a transverse beam 26C carried on a pivot pin 26D attached to the side of the hopper 21. The beam is generally pivoted about its mid-point at the pin 26D and the pin is arranged adjacent the outer end 28 of the hopper so that the outer end and particularly the bottom corner 21A of the hopper is supported against engagement with the ground. The beam 26C carries a pair of castor wheels 26E and 26F. Each of the castor wheels is of a conventional nature rotatable about a respective vertical axis 26G. The beam 26C is pivotal about the pin 26D, the axes 26G are maintained vertical so that the castor wheels can work effective to castor around the axis. The beam 26C thus acts as a walking beam so that both of the wheels of the pair attached to the walking beam remain in contact with the ground at all times in their castoring action.

In this way the hopper can be moved both side to side and in a direction at right angles to the side of the tank simply by the castor wheels following the direction of movement in their conventional castoring action.

The apparatus of the present invention includes the components described above which operate to move the conveyor duct between the transport position along side the seeder tank to the deployed position extending outwardly to one side at right angles to the side wall with the ground wheels sitting on the ground.

Thus the container 10 has a side wall 10A on which the bracket 10B for the above mechanism is mounted. The conveyor duct 18 is an auger to move the seeds within the duct from the hopper 21 to the spout 20. In addition to the mounting system previously described there is a cradle 70 carried on the side wall 10A of the container 10 for receiving a portion 18A of the conveyor duct 18 therein when in a transport position along the side wall of the container. Thus in transport the auger is held in stable position by the operating system and its support cradle 54 previously described and the cradle 70. The cradle 70 is carried on an arm 71 movable relative to the container on a vertical pivot pin 72 so as to be moveable relative to the container. The vertical pivot pin 72 is carried on the bracket 10B on the side 10A of the container 10 so that the arm moves horizontally.

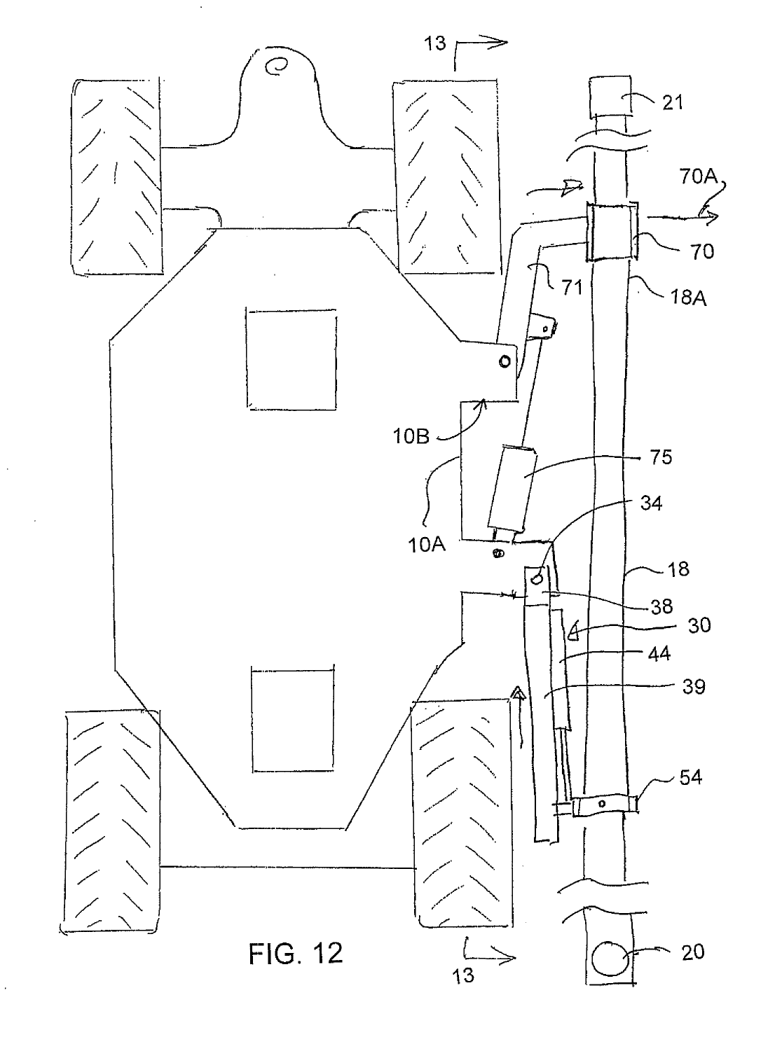

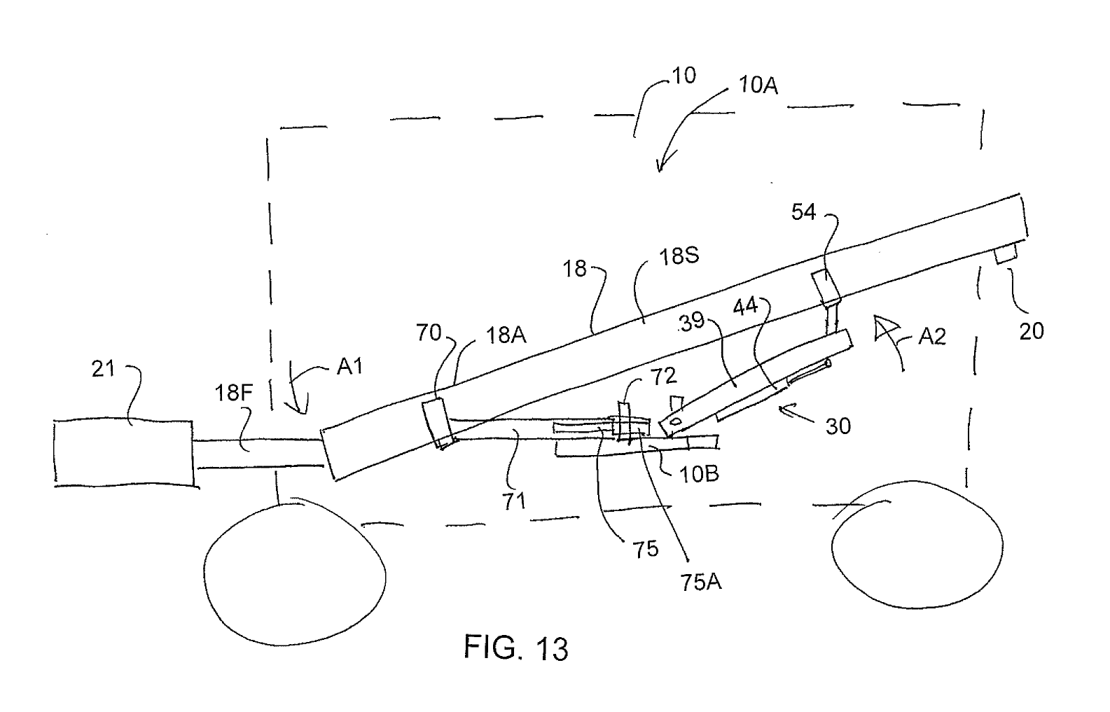

The arm 71 is arranged to move the cradle from the retracted transport position shown in FIGS. 12 and 13 adjacent the side wall where the arm 71 is parallel to the side wall to a partly extended position indicated at arrow 70A extending at an angle away from the side wall for releasing the conveyor duct 18

An operating linkage 75 is provided for moving the arm 71 in response to operation of the mounting assembly 30 in a deployment action.

As shown the linkage 75 is a hydraulic cylinder driven in response to supply of fluid to the cylinder 44. In an alternative arrangement the linkage 75 is in the form of a lever mechanically connected between the lever 39 and the lever 70.

In both cases the linkage is arranged to move the arm 71 horizontally about the vertical pin 72 to carry the cradle 70 away from the side wall 10A when the mounting assembly 30 is operated to lift the cradle 54 and the conveyor duct carried thereon. That is the first action of the mounting assembly 30 is to operate the cylinder 44 from the position shown in FIG. 5 to lift the cradle 54 and the part of the conveyor 18 attached to the cradle 54. This acts to pull the conveyor duct upwardly and at the same time to swing the arm 71 and the cradle 70 outwardly from the side wall 10A to the position shown at 70A.

At the same time, the cradle 70 is arranged such that lifting of the conveyor duct 18 by the mounting assembly 30 causes the conveyor duct 18 to tilt at the portion 18A about the cradle 70 in a teeter totter action as shown at arrows A1 and A2 in FIG. 13 to lower the hopper 21 on the ground wheels 26 to the ground. With the ground wheels 26 on the ground and the cradle 70 pivoted outwardly away from the side wall, the further movement of the mounting assembly 30 causes the conveyor duct to lift off the cradle 70 without manual intervention and to be therefore free to move to the deployed position previously described.

In this way deployment movement is fully automatic. In a reverse action, the movement to the transport position is also carried out without manual operation of the position of the auger.

Also in the reverse action, with the hopper 21 and its ground wheels on the ground, the duct 18 can be located into the cradle 70 while the arm 39 is in its raised position. From this position downward movement of the arm 39 causes the teeter totter action on a fulcrum defined by the cradle 70 to cause the hopper to be lifted from the ground for a transport position. This lifting occurs without manual assistance. In order to achieve the teeter totter lifting action, the cradle 70 is located at a position close to the center of the duct so that the arm 39 adjacent the upper end provides sufficient movement to lift the hopper off the ground. A simple calculation of the required distances to achieve this operation can be carried out.

In a further feature shown in FIG. 12, the auger includes a first auger tube portion 18F extending from the hopper 21 and a second portion 18S extending from an end of the first portion to the spout 20, where the first position 18F and its associated auger flight is of smaller diameter, such as 8 inches, than the diameter, such as 10 inches, of the second portion 18S.

The first portion 18F is generally parallel to the hopper floor and at an angle to the second portion 18S. In this way the feeding action can proceed with little or no manual intervention since the second portion 18S can be relied upon carries away all material carried from the hopper 21 by the first portion 18F.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus comprising:
a container having a side wall;
a conveyor duct having a conveyor member mounted therein and operable to move a particulate material within the duct from a lower feed end to an upper discharge end;
a hopper at the lower feed end into which the particulate material can be poured;
a discharge spout at the upper discharge end for discharging the particulate material from the duct;
at least one ground wheel on the hopper for supporting the hopper for movement over the ground;
a mounting assembly for mounting the conveyor duct on the container for movement relative thereto between a transport position along the side wall of the container to a deployed position extending outwardly from the side wall with the ground wheel of the hopper on the ground, the mounting assembly comprising:
a support bracket mounted on the side wall of the container;
a first portion mounted on the support bracket for pivotal movement about an upright axis such that the first portion can turn about the axis from a position along the side wall of the container to a position extending outwardly from the side wall of the container;
an arm portion having an inner end mounted on the first portion for pivotal movement about a transverse axis on the first portion such that the arm portion can move from a raised position to a lowered position;
and a coupling attaching an outer end of the arm to the conveyor duct;
and a cradle carried by the container for receiving the conveyor duct therein when in a transport position along the side wall of the container;
the cradle being carried on an arm movable relative to the container so as to be moveable relative to the container.

2. The apparatus according to claim 1 wherein the arm is arranged to move the cradle from a retracted transport position adjacent the side wall to an extended position away from the side wall for releasing the conveyor duct.

3. The apparatus according to claim 1 wherein the arm moves horizontally.

4. The apparatus according to claim 1 wherein there is provided a linkage for moving the arm in response to operation of the mounting assembly.

5. The apparatus according to claim 4 wherein the linkage is arranged to move the arm horizontally to carry the cradle away from the side wall when the mounting assembly is operated to lift the conveyor duct.

6. The apparatus according to claim 1 wherein the cradle is arranged to provide a fulcrum at a position part way along the conveyor duct and arranged such that movement of the arm portion downwardly from the raised position causes a lifting movement of the hopper from the ground.

7. The apparatus according to claim 1 wherein the cradle is arranged such that lifting of the conveyor duct by the mounting assembly causes the conveyor duct to tilt about the cradle to lower the ground wheel to the ground.

8. The apparatus according to claim 1 wherein the conveyor duct comprises an auger which includes a first portion extending from the hopper and a second portion extending from an end of the first portion to the spout, wherein the first position is of smaller diameter than the second portion.

9. The apparatus according to claim 8 wherein the first portion is at an angle to the second portion and generally parallel to the hopper floor.

10. The apparatus according to claim 1 wherein the mounting assembly comprises:
an arm portion having an inner end mounted on the first portion for pivotal movement about a transverse axis on the first portion such that the arm portion can move from a raised position standing substantially vertically upwardly from the first portion along the side wall of the container to a lowered position extending outwardly from the side wall of the container;
a drive member for driving movement of the arm portion between the raised and lowered positions;
said at least one ground wheel being arranged to support the hopper while allowing rolling movement of the wheel in a direction longitudinally of the duct;
and a swivel connection between the outer end of the arm portion and the conveyor duct at a position on the conveyor duct intermediate the upper and lower ends;
the swivel connection being arranged to support the conveyor duct at the outer end of the arm portion;
the swivel connection being arranged to allow the conveyor duct to pivot about a horizontal axis transverse to the duct such that the conveyor duct can change in angle relative to the arm portion as the arm portion moves between the raised and lowered positions;
the swivel connection being arranged such that, with the hopper resting on the ground wheel in contact with the ground and the arm portion in the lowered position extending outwardly from the side wall of the container, the duct extends longitudinally of the arm portion and is held such that it passes upwardly above the outer end of the arm portion;
the swivel connection being arranged such that movement of the arm portion from the lowered position to the raised position causes the hopper to be pulled in toward the container while lifting the upper end of the conveyor duct upward, while the at least one ground wheel rolls over the ground and while maintaining the duct in position relative to the outer end of the arm portion such that the duct passes upwardly above the outer end of the arm portion;
and the swivel connection being arranged to allow the conveyor duct to pivot about an upright axis at the outer end of the arm portion.

11. Apparatus comprising:
a container having a side wall;
a conveyor duct having a conveyor member mounted therein and operable to move a particulate material within the duct from a lower feed end to an upper discharge end;
a hopper at the lower feed end into which the particulate material can be poured;
a discharge spout at the upper discharge end for discharging the particulate material from the duct;
at least one ground wheel on the hopper for supporting the hopper for movement over the ground;
a mounting assembly for mounting the conveyor duct on the container for movement relative thereto between a transport position along the side wall of the container to a deployed position extending outwardly from the side wall with the ground wheel of the hopper on the ground, the mounting assembly comprising:
a support bracket mounted on the side wall of the container;
a first portion mounted on the support bracket for pivotal movement about an upright axis such that the first portion can turn about the axis from a position along the side wall of the container to a position extending outwardly from the side wall of the container;
an arm portion having an inner end mounted on the first portion for pivotal movement about a transverse axis on the first portion such that the arm portion can move from a raised position to a lowered position;
and a coupling attaching an outer end of the arm to the conveyor duct;
and a cradle carried by the container for receiving the conveyor duct therein when in a transport position along the side wall of the container;
the cradle providing a fulcrum at a position part way along the conveyor duct and arranged such that movement of the arm portion downwardly from the raised position causes a lifting movement of the hopper from the ground.

12. The apparatus according to claim 11 wherein the cradle is arranged such that lifting of the conveyor duct by the mounting assembly causes the conveyor duct to tilt about the cradle to lower the ground wheel to the ground.

13. Apparatus comprising:
a container having a side wall;
a conveyor duct having a conveyor member mounted therein and operable to move a particulate material within the duct from a lower feed end to an upper discharge end;
a hopper at the lower feed end into which the particulate material can be poured;
a discharge spout at the upper discharge end for discharging the particulate material from the duct;
at least one ground wheel on the hopper for supporting the hopper for movement over the ground;
a mounting assembly for mounting the conveyor duct on the container for movement relative thereto between a transport position along the side wall of the container to a deployed position extending outwardly from the side wall with the ground wheel of the hopper on the ground, the mounting assembly comprising:
a support bracket mounted on the side wall of the container;
a first portion mounted on the support bracket for pivotal movement about an upright axis such that the first portion can turn about the axis from a position along the side wall of the container to a position extending outwardly from the side wall of the container;
an arm portion having an inner end mounted on the first portion for pivotal movement about a transverse axis on the first portion such that the arm portion can move from a raised position to a lowered position;
and a coupling attaching an outer end of the arm to the conveyor duct;
wherein the conveyor duct comprises an auger which includes a first portion extending from the hopper and a second portion extending from an end of the first portion to the spout, wherein the first position is of smaller diameter than the second portion.

14. The apparatus according to claim 13 wherein the first portion is at an angle to the second portion and generally parallel to the hopper floor.
